(19) United States
(12) Patent Application Publication
(10) Pub. No.: US 2024/0106603 A1
(43) Pub. Date: Mar. 28, 2024

(54) COMMUNICATION METHOD AND APPARATUS

(71) Applicant: Beijing Xiaomi Mobile Software Co., Ltd., Beijing (CN)

(72) Inventor: Yuanyuan LI, Beijing (CN)

(73) Assignee: Beijing Xiaomi Mobile Software Co., Ltd., Beijing (CN)

(21) Appl. No.: 18/270,352

(22) PCT Filed: Dec. 31, 2020
(86) PCT No.: PCT/CN2020/142537

§ 371 Date: Jun. 29, 2023

(51) Int. Cl. H04L 5/00

(52) U.S. Cl. CPC H04L 5/0051

(57) ABSTRACT

A communication method includes: configuring transmission of a reference signal for cross-time-unit transmission or on the basis of a reference signal configuration parameter, wherein the reference signal is configured for phase estimation, and frequency domain resources occupied by the transmission of the reference signal is less than frequency domain resources occupied by the transmission of a demodulation reference signal (DMRS).

### CROSS-REFERENCE

The present application is a U.S. National Stage of International Application No. PCT/CN2020/142537, filed on Dec. 31, 2020, the contents of all of which are incorporated herein by reference in their entireties for all purposes.

### BACKGROUND

Currently, as the network technology develops, a terminal needs to perform coverage enhancement in order to satisfy higher requirements of network services for a transmission rate and a delay, for instance.

### SUMMARY

An example of a first aspect of the disclosure provides a communication method. The communication method includes: configuring, based on a reference signal configuration parameter, transmission of a reference signal for cross-time-unit transmission or repetition, where the reference signal is configured for phase estimation, and frequency domain resources occupied by the transmission of the reference signal are less than frequency domain resources occupied by transmission of a demodulation reference signal (DMRS).

An example of a second aspect of the disclosure provides another communication method. The communication method includes: receiving, based on a reference signal configuration parameter, transmission of a reference signal for cross-time-unit transmission or repetition from a base station, where the reference signal is configured for phase estimation, and frequency domain resources occupied by the transmission of the reference signal are less than frequency domain resources occupied by transmission of a DMRS.

An example of a third aspect of the disclosure provides yet another communication method. The communication method includes: configuring or receiving, for two adjacent time units in cross-time-unit transmission or repetition, signal transmission in a last symbol of a first time unit and a first symbol of a second time unit respectively, where the signal transmission is configured for phase estimation.

An example of a fourth aspect of the disclosure provides an electronic device. The electronic device includes: at least one processor; and a memory communicatively connected to the at least one processor, where the memory stores an instruction executable by the at least one processor, and the instruction, when being executed by the at least one processor, enables the at least one processor to perform the communication method according to the example of the first aspect of the disclosure, or the communication method according to the example of the second aspect of the disclosure, the communication method according to the example of the third aspect of the disclosure.

An example of a fifth aspect of the disclosure provides a non-transitory computer-readable storage medium. The non-transitory computer-readable storage medium stores a computer instruction, where the computer instruction is configured to enable a computer to perform the communication method according to the example of the first aspect of the disclosure, or the communication method according to the example of the second aspect of the disclosure, or the communication method according to the example of the third aspect of the disclosure.

Additional aspects and advantages of the disclosure will be set forth partially in the following description, which will become obvious in the following description, or will be learned by practice of the disclosure.

### BRIEF DESCRIPTION OF THE DRAWINGS

The aspects and/or additional aspects and advantages of the disclosure will become obvious and comprehensible from the description of examples in conjunction with accompanying drawings below.

FIG. 1 is a schematic flow diagram of a communication method according to an example of the disclosure;

FIG. 2 is a schematic diagram of another communication method according to an example of the disclosure;

FIG. 3 is a schematic flow diagram of yet another communication method according to an example of the disclosure;

FIG. 4 is a schematic flow diagram of yet another communication method according to an example of the disclosure;

FIG. 5 is a schematic flow diagram of yet another communication method according to an example of the disclosure;

FIG. 6 is a schematic flow diagram of still another communication method according to an example of the disclosure; and

FIG. 7 is a schematic structural diagram of an electronic device according to an example of the disclosure.

### DETAILED DESCRIPTION

Examples of the disclosure will be described in detail below. Instances of the examples are shown in accompanying drawings, throughout which identical or similar reference numerals indicate identical or similar elements or elements having identical or similar functions. The examples described with reference to the accompanying drawings are illustrative and intended to explain the disclosure rather than be construed as limiting the disclosure.

The disclosure relates to the field of communication, and particularly relates to a communication method and a communication apparatus.

In the related art, the coverage enhancement can be performed through a method for reducing a density of the DMRS. However, the method may bring a problem of phase jump. A demodulation reference signal transmitted in a previous time unit only represents a phase change of the transmission this time in a frequency domain, while a phase change caused by transmission in a next time unit cannot be tracked. In this way, compensation for phase distortion of transmission in the next time unit cannot be performed. Further, subsequent demodulation is influenced, and transmission performance is decreased.

The disclosure provides a communication method and a communication apparatus, a terminal, a base station, an electronic device, and a storage medium, so as to solve a problem that a phase cannot be accurately tracked when coverage enhancement is performed through a method for reducing a density of a demodulation reference signal in the related art.

A base station involved in an example of the disclosure is specifically described as follows: the base station (BS) is deployed in a wireless access network, and provides a wireless access function for a terminal. The base station may be in wireless communication with the terminal via one or more antennas. The base station may provide communication coverage for a geographical area where the base station is located. The base stations may include a macro site, a micro site, a relay station, an access point, and the like in different types. In some examples, the base station may be referred to as a base transceiver station, a wireless base station, an access point, a wireless transceiver, a basic service set (BSS), an extended service set (ESS), a node B, an evolved node B (eNB or eNodeB) or some other appropriate terms by those skilled in the art. For instance, in a 5th generation mobile communication technology (5G) system, the base station is referred to as a generation node B (gNB). For convenience of description, in the example of the disclosure, the above devices for providing a wireless communication function for the terminal are collectively referred to as the base station.

The terminals involved in the example of the disclosure are specifically described as follows: the terminals may be distributed throughout an entire mobile communication system, and each terminal may be stationary or mobile. The terminal may also be referred to as a mobile station, a user station, a mobile unit, a user unit, a wireless unit, a remote unit, a mobile device, a terminal device, a wireless device, a wireless communication device, a remote device, a mobile user station, an access user device, a mobile user device, a wireless user device, a remote user device, a handheld device, a user agent, a mobile client, a client or some other appropriate terms by those skilled in the art. The terminal may be a cellular phone, a personal digital assistant (PDA), a wireless modem, a wireless communication device, a handheld device, a tablet computer, a laptop computer, a cordless phone, a wireless local loop (WLL) station, and the like, and may be in communication with the base station in the mobile communication system.

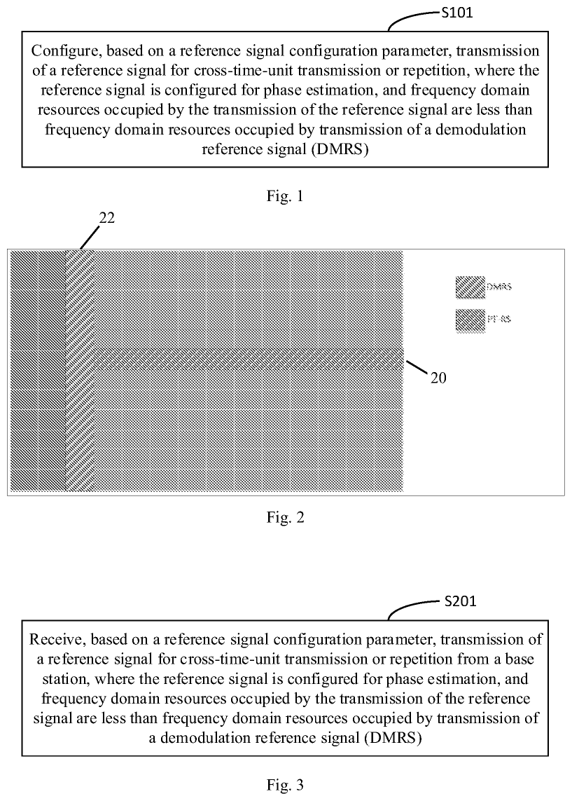

FIG. 1 is a schematic flow diagram of a communication method according to an example of the disclosure. The communication method is performed by a terminal. As shown in FIG. 1, the communication method includes the following step:

in S101, transmission of a reference signal is configured for cross-time-unit transmission or repetition based on a reference signal configuration parameter, where the reference signal is configured for phase estimation, and frequency domain resources occupied by the transmission of the reference signal are less than frequency domain resources occupied by transmission of a demodulation reference signal (DMRS).

In the example of the disclosure, the transmission of the reference signal may be configured for the cross-time-unit transmission or repetition based on the reference signal configuration parameter, where the reference signal is configured for phase estimation, and the frequency domain resources occupied by the transmission of the reference signal are less than the frequency domain resources occupied by the transmission of the DMRS. In this way, the terminal may implement phase tracking and calibration according to the transmission of the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

For instance, as shown in FIG. 2, the frequency domain resources 20 occupied by the transmission of the reference signal are less than the frequency domain resources 22 occupied by the transmission of the DMRS.

Alternatively, the reference signal is a phase tracking reference signal (PT-RS).

Alternatively, the step that the reference signal is configured for the cross-time-unit transmission or repetition is performed in response to notification indication information from a base station. It may be understood that the base station may transmit the notification indication information to the terminal. Accordingly, the terminal may configure the reference signal for the cross-time-unit transmission or repetition in response to the notification indication information from the base station.

The notification indication information includes a start notification indication of a demodulation reference signal density reduction (DMRS-less) mode. It may be understood that the terminal may further be started in the DMRS-less mode in response to the start notification indication of the DMRS-less mode, so as to perform coverage enhancement by reducing the density of the DMRS.

Alternatively, the reference signal configuration parameter is determined by at least one of the following ways: the reference signal configuration parameter is determined based on control signaling from the base station; and alternatively, the reference signal configuration parameter is determined according to a communication protocol or a pre-configuration.

Alternatively, the reference signal configuration parameter includes at least one of the following parameters: a time domain density; a frequency domain density; an initial time domain offset; or an initial frequency domain offset of the reference signal.

It may be understood that the time domain density, the frequency domain density, the initial time domain offset and the initial frequency domain offset may all be set according to an actual condition. For instance, the initial time domain offset of the transmission of the reference signal in a time unit occupied by the cross-time-unit transmission or repetition is determined based on a first time domain symbol occupied by the cross-time-unit transmission or repetition in a first time unit occupied by the cross-time-unit transmission or repetition, and the initial frequency domain offset of the transmission of the reference signal in a time unit occupied by the cross-time-unit transmission or repetition is determined based on a first frequency domain resource unit occupied by the cross-time-unit transmission or repetition in a first time unit occupied by the cross-time-unit transmission or repetition.

Alternatively, the step that the transmission of the reference signal is configured for the cross-time-unit transmission or repetition includes the step that the transmission of the reference signal is configured in at least part of time units occupied by the cross-time-unit transmission or repetition, where at least one time unit in part of the time units does not include the transmission of the DMRS. That is, the transmission of the reference signal may be discontinuous in a time domain, which is beneficial for reducing the number of reference signals, increasing transmission of data information, and further improving coverage performance.

Alternatively, the step that the transmission of the reference signal is configured for the cross-time-unit transmission or repetition includes the step that based on a modulation and coding scheme (MCS) level, the transmission of the reference signal is determined to be not configured for the cross-time-unit transmission or repetition. It may be understood that if a current modulation and coding scheme (MCS) level may tolerate a phase deviation caused by the cross-time-unit transmission or repetition, the transmission of the reference signal may be determined to be not configured for the cross-time-unit transmission or repetition. In this way, the method may consider influence of the modulation and coding scheme (MCS) level on configuration of the transmission of the reference signal for the cross-time-unit transmission or repetition, which is more flexible.

It is to be noted that in the example of the disclosure, a frequency band where the terminal operates is not limited. For instance, the terminal may operate in an FR1 frequency band specified by a communication protocol. In addition, the time unit includes, but is not limited to, a slot, a transmission time interval (TTI), and the like, which is not limited here. In addition, a type of a channel where the time unit is located is not limited. For instance, the time unit may be a time unit in a physical uplink shared channel (PUSCH), or a time unit in a physical uplink control channel (PUCCH).

According to the communication method in the examples of the disclosure, the terminal configures, based on the reference signal configuration parameter, the transmission of the reference signal for the cross-time-unit transmission or repetition, where the reference signal is configured for phase estimation, and the frequency domain resources occupied by the transmission of the reference signal are less than the frequency domain resources occupied by the transmission of the DMRS. In this way, the terminal may implement phase tracking and calibration according to the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

FIG. 3 is a schematic flow diagram of yet another communication method according to an example of the disclosure. The communication method is performed by a terminal. As shown in FIG. 3, the communication method includes the following step:

in S201, transmission of a reference signal is received for cross-time-unit transmission or repetition from a base station based on a reference signal configuration parameter, where the reference signal is configured for phase estimation, and frequency domain resources occupied by the transmission of the reference signal are less than frequency domain resources occupied by transmission of a demodulation reference signal (DMRS).

In the example of the disclosure, the terminal may receive, based on the reference signal configuration parameter, the transmission of the reference signal for the cross-time-unit transmission or repetition from the base station, where the reference signal is configured for phase estimation, and the frequency domain resources occupied by the transmission of the reference signal are less than frequency domain resources occupied by the transmission of the DMRS. In this way, the terminal may implement phase tracking and calibration according to the received transmission of the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

Alternatively, the step that the transmission of the reference signal is received for the cross-time-unit transmission or repetition includes the step that the transmission of the reference signal is received in at least part of time units occupied by the cross-time-unit transmission or repetition, where at least one time unit in part of the time units does not include the transmission of the DMRS. That is, the transmission of the reference signal may be discontinuous in a time domain, which is beneficial for reducing the number of reference signals, increasing transmission of data information, and further improving coverage performance.

According to the communication method in the example of the disclosure, the terminal receives, based on the reference signal configuration parameter, the transmission of the reference signal for the cross-time-unit transmission or repetition from the base station, where the reference signal is configured for phase estimation, and the frequency domain resources occupied by the transmission of the reference signal are less than the frequency domain resources occupied by the transmission of the DMRS. In this way, the terminal may implement phase tracking and calibration according to the received transmission of the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

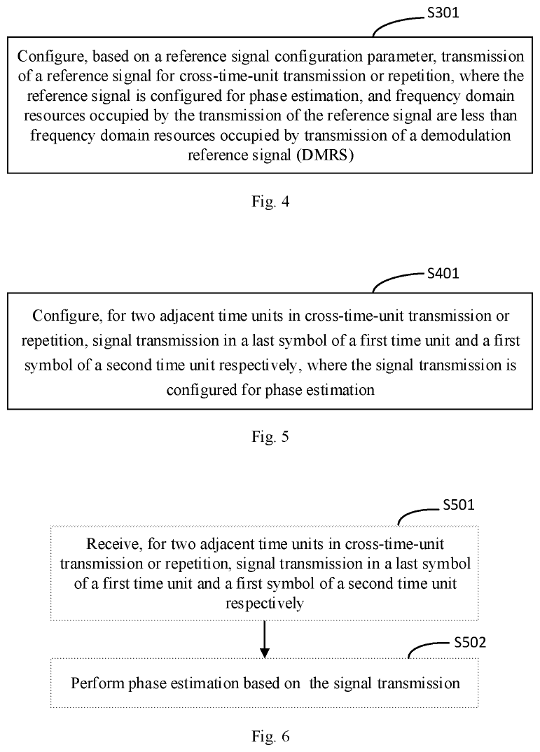

FIG. 4 is a schematic flow diagram of yet another communication method according to an example of the disclosure. The communication method is performed by a base station. As shown in FIG. 4, the communication method includes the following step:

in S301, transmission of a reference signal is configured for cross-time-unit transmission or repetition based on a reference signal configuration parameter, where the reference signal is configured for phase estimation, and frequency domain resources occupied by the transmission of the reference signal are less than frequency domain resources occupied by transmission of a demodulation reference signal (DMRS).

According to the communication method in the example of the disclosure, the base station may configure, based on the reference signal configuration parameter, the transmission of the reference signal for the cross-time-unit transmission or repetition, where the reference signal is configured for phase estimation, and the frequency domain resources occupied by the transmission of the reference signal are less than the frequency domain resources occupied by the transmission of the DMRS. In this way, the base station may implement phase tracking and calibration according to the transmission of the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

FIG. 5 is a schematic flow diagram of yet another communication method according to an example of the disclosure. The communication method is performed by a base station or a terminal. As shown in FIG. 5, the communication method includes the following step:

in S401, for two adjacent time units in cross-time-unit transmission or repetition, signal transmission is configured in a last symbol of a first time unit and a first symbol of a second time unit respectively, where the signal transmission is configured for phase estimation.

In the example of the disclosure, the base station or the terminal may configure, for the two adjacent time units in the cross-time-unit transmission or repetition, the signal transmission in the last symbol of the first time unit and the first symbol of the second time unit respectively, where the signal transmission is configured for phase estimation. That is, the signal transmission may be configured in time domain edge symbols of the two adjacent time units respectively. In this way, both the two adjacent time units are configured with the signal transmission, and phase estimation may be performed by using the signal transmission of the two time units. Further, a problem that phases of the same transport block size (TBS) are discontinuous in the cross-time-unit transmission may be solved, which is beneficial for ensuring correctness of demodulation and improving transmission performance.

Alternatively, the signal transmission is transmission of the same service data or transmission of the DMRS.

According to the communication method in the example of the disclosure, the base station or the terminal may configure, for the two adjacent time units in the cross-time-unit transmission or repetition, the signal transmission in the last symbol of the first time unit and the first symbol of the second time unit respectively, where the signal transmission is configured for phase estimation. In this way, both the two adjacent time units are configured with the signal transmission, and phase estimation may be performed by using the signal transmission of the two time units. Further, a problem that phases of the same TBS are discontinuous in the cross-time-unit transmission may be solved, which is beneficial for ensuring correctness of demodulation and improving transmission performance.

FIG. 6 is a schematic flow diagram of still another communication method according to an example of the disclosure. The communication method is performed by a base station or a terminal. As shown in FIG. 6, the communication method includes the following steps:

in S501, for two adjacent time units in cross-time-unit transmission or repetition, signal transmission is received in a last symbol of a first time unit and a first symbol of a second time unit respectively.

in S502, phase estimation is performed based on the signal transmission.

Alternatively, the signal transmission is transmission of the same service data or transmission of a demodulation reference signal (DMRS).

According to the communication method in the example of the disclosure, the base station or the terminal may receive, for the two adjacent time units in the cross-time-unit transmission or repetition, the signal transmission in the last symbol of the first time unit and the first symbol of the second time unit respectively, and perform phase estimation based on the signal transmission. In this way, both the two adjacent time units are configured with the signal transmission, and phase estimation may be performed by using the signal transmission of the two time units. Thus, a problem that phases of the same transport block size (TBS) are discontinuous in the cross-time-unit transmission may be solved, which is beneficial for ensuring correctness of demodulation and improving transmission performance.

Corresponding to the communication method according to the above examples, the disclosure further provides a communication apparatus. The communication apparatus is performed by a terminal. Since the communication apparatus according to the example of the disclosure corresponds to the communication method according to the example of FIG. 1, embodiments of the communication method are also applicable to the communication apparatus according to the example, which will not be described in details in the example.

The communication apparatus according to the example of the disclosure is performed by the terminal. The communication apparatus includes: a first configuration module configured to configure, based on a reference signal configuration parameter, transmission of a reference signal for cross-time-unit transmission or repetition, where the reference signal is configured for phase estimation, and frequency domain resources occupied by the transmission of the reference signal are less than frequency domain resources occupied by transmission of a demodulation reference signal (DMRS).

According to the communication apparatus in the example of the disclosure, the transmission of the reference signal is configured for the cross-time-unit transmission or repetition based on the reference signal configuration parameter, where the reference signal is configured for phase estimation, and the frequency domain resources occupied by the transmission of the reference signal are less than the frequency domain resources occupied by the transmission of the DMRS. In this way, the apparatus may implement phase tracking and calibration according to the reference signal, such that a problem that a phase cannot be accurately tracked when coverage enhancement is performed through a method for reducing a density of the demodulation reference signal in the related art may be solved, which is beneficial for ensuring correctness of demodulation and improving transmission performance.

Corresponding to the communication method according to the above examples, the disclosure further provides a communication apparatus. The communication apparatus is performed by a terminal. Since the communication apparatus according to the example of the disclosure corresponds to the communication method according to the example of FIG. 3, embodiments of the communication method are also applicable to the communication apparatus according to the example, which will not be described in details in the example.

The communication apparatus according to the example of the disclosure is performed by the terminal. The communication apparatus includes: a receiving module configured to receive, based on a reference signal configuration parameter, transmission of a reference signal for cross-time-unit transmission or repetition from a base station, where the reference signal is configured for phase estimation, and frequency domain resources occupied by the transmission of the reference signal are less than frequency domain resources occupied by transmission of a demodulation reference signal (DMRS).

According to the communication apparatus in the example of the disclosure, the transmission of the reference signal is received for the cross-time-unit transmission or repetition from the base station based on the reference signal configuration parameter, where the reference signal is configured for phase estimation, and the frequency domain resources occupied by the transmission of the reference signal are less than the frequency domain resources occupied by the transmission of the DMRS. In this way, the apparatus may implement phase tracking and calibration according to the received transmission of the reference signal, such that a problem that a phase cannot be accurately tracked when coverage enhancement is performed through a method for reducing a density of the demodulation reference signal in the related art may be solved, which is beneficial for ensuring correctness of demodulation and improving transmission performance.

Corresponding to the communication method according to the above examples, the disclosure further provides a communication apparatus. The communication apparatus is performed by a terminal. Since the communication apparatus according to the example of the disclosure corresponds to the communication method according to the example of FIG. 4, embodiments of the communication method are also applicable to the communication apparatus according to the example, which will not be described in details in the example.

The communication apparatus according to the example of the disclosure is performed by a base station. The communication apparatus includes: a second configuration module configured to configure, based on a reference signal configuration parameter, transmission of a reference signal for cross-time-unit transmission or repetition, where the reference signal is configured for phase estimation, and frequency domain resources occupied by the transmission of the reference signal are less than frequency domain resources occupied by transmission of a demodulation reference signal (DMRS).

According to the communication apparatus in the example of the disclosure, the transmission of the reference signal may be configured for the cross-time-unit transmission or repetition based on the reference signal configuration parameter, where the reference signal is configured for phase estimation, and the frequency domain resources occupied by the transmission of the reference signal are less than the frequency domain resources occupied by the transmission of the DMRS. In this way, the apparatus may implement phase tracking and calibration according to the transmission of the reference signal, such that a problem that a phase cannot be accurately tracked when coverage enhancement is performed through a method for reducing a density of the demodulation reference signal in the related art may be solved, which is beneficial for ensuring correctness of demodulation and improving transmission performance.

Corresponding to the communication method according to the above examples, the disclosure further provides a communication apparatus. The communication apparatus is performed by a terminal. Since the communication apparatus according to the example of the disclosure corresponds to the communication method according to the example of FIG. 5, embodiments of the communication method are also applicable to the communication apparatus according to the example, which will not be described in details in the example.

The communication apparatus according to the example of the disclosure includes: a third configuration module configured to configure, for two adjacent time units in cross-time-unit transmission or repetition, signal transmission in a last symbol of a first time unit and a first symbol of a second time unit respectively, where the signal transmission is configured for phase estimation.

According to the communication apparatus in the example of the disclosure, for the two adjacent time units in the cross-time-unit transmission or repetition, the signal transmission may be configured in the last symbol of the first time unit and the first symbol of the second time unit respectively, where the signal transmission is configured for phase estimation. In this way, both the two adjacent time units are configured with the signal transmission, and phase estimation may be performed by using the signal transmission of the two time units. Further, a problem that phases of the same transport block size (TBS) are discontinuous in the cross-time-unit transmission may be solved, which is beneficial for ensuring correctness of demodulation and improving transmission performance.

Corresponding to the communication method according to the above examples, the disclosure further provides a communication apparatus. The communication apparatus is performed by a terminal. Since the communication apparatus according to the example of the disclosure corresponds to the communication method according to the example of FIG. 6, embodiments of the communication method are also applicable to the communication apparatus according to the example, which will not be described in details in the example.

The communication apparatus according to the example of the disclosure includes: a second receiving module configured to receive, for two adjacent time units in cross-time-unit transmission or repetition, signal transmission in a last symbol of a first time unit and a first symbol of a second time unit respectively; and an estimation module configured to conduct phase estimation based on the signal transmission.

According to the communication apparatus in the example of the disclosure, for the two adjacent time units in the cross-time-unit transmission or repetition, the signal transmission may be received in the last symbol of the first time unit and the first symbol of the second time unit respectively, and phase estimation may be performed based on the signal transmission. In this way, both the two adjacent time units are configured with the signal transmission, and phase estimation may be performed by using the signal transmission of the two time units. Further, a problem that phases of the same transport block size (TBS) are discontinuous in the cross-time-unit transmission may be solved, which is beneficial for ensuring correctness of demodulation and improving transmission performance.

According to an example of the disclosure, the disclosure further provides a terminal. The terminal includes the communication apparatus according to the example of the disclosure.

According to the terminal in the example of the disclosure, the terminal configures, based on a reference signal configuration parameter, transmission of a reference signal for cross-time-unit transmission or repetition, where the reference signal is configured for phase estimation, and frequency domain resources occupied by the transmission of the reference signal are less than frequency domain resources occupied by transmission of a demodulation reference signal (DMRS). In this way, the terminal may implement phase tracking and calibration according to the reference signal, such that a problem that a phase cannot be accurately tracked when coverage enhancement is performed through a method for reducing a density of the demodulation reference signal in the related art may be solved, which is beneficial for ensuring correctness of demodulation and improving transmission performance.

According to an example of the disclosure, the disclosure further provides a base station. The base station includes the communication apparatus according to the example of the disclosure.

According to the base station in the example of the disclosure, transmission of a reference signal may be configured for cross-time-unit transmission or repetition based on a reference signal configuration parameter, where the reference signal is configured for phase estimation, and frequency domain resources occupied by the transmission of the reference signal are less than frequency domain resources occupied by transmission of a demodulation reference signal (DMRS). In this way, the base station may implement phase tracking and calibration according to the transmission of the reference signal, such that a problem that a phase cannot be accurately tracked when coverage enhancement is performed through a method for reducing a density of the demodulation reference signal in the related art may be solved, which is beneficial for ensuring correctness of demodulation and improving transmission performance.

According to an example of the disclosure, the disclosure further provides an electronic device and a non-transitory computer-readable storage medium.

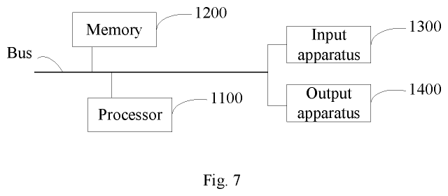

FIG. 7 is a block diagram of an electronic device according to an example of the disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. The components shown here, and connections and relations between the components and functions of the components are illustrative, and are not intended to limit implementations of the disclosure described and/or claimed here.

As shown in FIG. 7, the electronic device includes: one or more processors 1100, a memory 1200, and interfaces for connecting all components, which include a high-speed interface and a low-speed interface. All the components are connected to one another with different buses, and may be mounted on a common mainboard or in other ways as required. The processor may process instructions executed in the electronic device, which include instructions stored in or on the memory so as to display graphical information of a graphical user interface (GUI) on an external input/output apparatus (such as a display apparatus coupled to the interface). In other embodiments, a plurality of processors and/or a plurality of buses may be used with a plurality of memories if required. Similarly, a plurality of electronic devices may be connected, and each device provides some necessary operations (for instance, serving as a server array, a group of blade servers, or a multiprocessor system). In FIG. 7, a processor 1100 is taken as an instance.

The memory 1200 is a non-transitory computer-readable storage medium according to the disclosure. The memory stores an instruction executable by at least one processor, so as to enable the at least one processor to perform the communication method according to the disclosure. The non-transitory computer-readable storage medium according to the disclosure stores a computer instruction, and the computer instruction is configured to enable a computer to perform the communication method according to the disclosure.

As a non-transitory computer-readable storage medium, the memory 1200 may be configured to store a non-transitory software program, a non-transitory computer-executable program and a module, such as a program instruction/module (for instance, a first configuration module 110 as shown in FIG. 4) corresponding to the communication method according to the example of the disclosure. The processor 1100 executes various functional applications and data processing of a server by running the non-transitory software program, the instruction and the modules stored in the memory 1200, that is, performs the communication method according to the above method example.

The memory 1200 may include a program storage area and a data storage area, where the program storage area may store an operating system and an application required for at least one function; and the data storage area may store data, and the like. created according to usage of a positioning electronic device. Moreover, the memory 1200 may include a high-speed random access memory, and may further include a non-volatile memory, for instance, at least one magnetic disk memory device, a flash memory device, or other non-volatile solid-state memory devices. Alternatively, the memory 1200 may include a memory remotely arranged with respect to the processor 1100, and the remote memory may be connected to the positioning electronic device by means of a network. Instances of the network include, but are not limited to, the Internet, enterprise intranets, local area networks, mobile communication networks, and combinations of the above networks.

The electronic device may further include: an input apparatus 1300 and an output apparatus 1400. The processor 1100, the memory 1200, the input apparatus 1300 and the output apparatus 1400 may be connected by means of buses or in other ways. In FIG. 7, a bus connection is taken as an instance.

The input apparatus 1300 may receive input digital or character information and generate key signal input related to user settings and function control of the positioning electronic device, for instance, a touch screen, a keypad, a mouse, a track pad, a touch pad, an indication rod, one or more mouse buttons, a trackball, a joystick, and other input apparatuses. The output apparatus 1400 may include a display apparatus, an auxiliary lighting apparatus (for instance, a light emitting diode (LED)), a tactile feedback apparatus (for instance, a vibration motor), and the like. The display apparatus may include, but is not limited to, a liquid crystal display (LCD), a light emitting diode (LED) display, and a plasma display. In some embodiments, the display apparatus may be a touch screen.

Various embodiments of systems and technologies described here may be implemented in a digital electronic circuit system, an integrated circuit system, an application-specific integrated circuit (ASIC), computer hardware, firmware, software, and/or combinations of the above. All the embodiments may include: an implementation in one or more computer programs, which may be executed and/or interpreted on a programmable system including at least one programmable processor, and the programmable processor may be a special-purpose or general-purpose programmable processor and capable of receiving and transmitting data and instructions from and to a storage system, at least one input apparatuses, and at least one output apparatuses.

Computation programs (also called programs, software, software applications, or codes) include a machine instruction of a programmable processor, and may be implemented by using high-level processes and/or object-oriented programming languages, and/or assembly/machine languages. As used here, the terms “machine-readable medium” and “computer-readable medium” refer to any computer program product, device, and/or apparatus (for instance, a magnetic disk, an optical disk, a memory, a programmable logic device (PLD)) configured to provide a machine instruction and/or data for a programmable processor, including a machine-readable medium receiving a machine instruction as a machine-readable signal. The term “machine-readable signal” refers to any signal configured to provide a machine instruction and/or data for a programmable processor.

To provide interaction with a user, the systems and technologies described here may be implemented on a computer. The computer includes: a display apparatus (for instance, a cathode ray tube (CRT) or a liquid crystal display (LCD) monitor) configured to display information to the user; and a keyboard and a pointing apparatus (for instance, a mouse or a trackball), through which the user may provide input for the computer. Other types of apparatuses may also provide interaction with the user. For instance, feedback provided for the user may be any form of sensory feedback (for instance, visual feedback, auditory feedback, or tactile feedback); and input from the user may be received in any form, including acoustic input, voice input, or tactile input.

The systems and technologies described here may be implemented in a computation system (for instance, as a data server) including a background component, or a computation system (for instance, an application server) including a middleware component, or a computation system (for instance, a user computer having a graphical user interface or a web browser through which a user may interact with the embodiments of the systems and technologies described here) including a front-end component, or a computation system including any combination of such background components, middleware components, or front-end components. The components of the system may be connected to each other through digital data communication in any form or medium (for instance, a communication network). Instances of the communication network include: a local area network (LAN), a wide area network (WAN), and the Internet.

A computer system may include a client and a server. The client and the server are generally far away from each other and typically interact with each other through a communication network. A relation between the client and the server is generated by computer programs operating on corresponding computers and having a client-server relation with each other.

According to the communication method in the examples of the disclosure, the terminal configures, based on the reference signal configuration parameter, the transmission of the reference signal for the cross-time-unit transmission or repetition, where the reference signal is configured for phase estimation, and the frequency domain resources occupied by the transmission of the reference signal are less than the frequency domain resources occupied by the transmission of the DMRS. In this way, the terminal may implement phase tracking and calibration according to the reference signal, such that the problem that the phase cannot be accurately tracked when coverage enhancement is performed through the method for reducing the density of the demodulation reference signal in the related art may be solved, which is beneficial for ensuring correctness of demodulation and improving transmission performance.

It is to be understood that steps can be reordered, added, or deleted based on various forms of procedures illustrated above. For instance, the steps described in the disclosure can be executed concurrently, sequentially or in a different order, so long as the desired results of the technical solutions disclosed in the disclosure can be achieved, which is not limited here.

1. A communication method comprising:
configuring, based on a reference signal configuration parameter, transmission of a reference signal for cross-time-unit transmission or repetition, wherein the reference signal is configured for phase estimation, and frequency domain resources occupied by the transmission of the reference signal are less than frequency domain resources occupied by transmission of a demodulation reference signal (DMRS).

2. The communication method according to claim 1, wherein the reference signal configuration parameter is determined by at least one of the following ways:
determining the reference signal configuration parameter based on control signaling from a base station; or,
determining the reference signal configuration parameter according to a communication protocol or a pre-configuration.

3. The communication method according to claim 1, wherein the terminal operates in an FR1 frequency band specified by a communication protocol.

4. The communication method according to claim 1, wherein the reference signal is a phase tracking reference signal (PT-RS).

5. The communication method according to claim 1, wherein the configuring transmission of a reference signal for cross-time-unit transmission or repetition is performed in response to notification indication information from a base station.

6. The communication method according to claim 5, wherein the notification indication information comprises a start notification indication of a demodulation reference signal density reduction (DMRS-less) mode.

7. The communication method according to claim 1, wherein the configuring transmission of a reference signal for cross-time-unit transmission or repetition comprises:
configuring the transmission of the reference signal in at least part of time units occupied by the cross-time-unit transmission or repetition, wherein at least one time unit in part of the time units doesn't comprise the transmission of the DMRS.

8. The communication method according to claim 7, wherein the configuring transmission of a reference signal for cross-time-unit transmission or repetition comprises: determining, based on a modulation and coding scheme (MCS) level, that the transmission of the reference signal is not configured for the cross-time-unit transmission or repetition.

9. The communication method according to claim 1, wherein the reference signal configuration parameter comprises at least one of the following parameters:
a time domain density;
a frequency domain density;
an initial time domain offset; or
an initial frequency domain offset of the reference signal.

10. The communication method according to claim 9, wherein the initial time domain offset of the transmission of the reference signal in a time unit occupied by the cross-time-unit transmission or repetition is determined based on a first time domain symbol occupied by the cross-time-unit transmission or repetition in a first time unit occupied by the cross-time-unit transmission or repetition; and/or,
the initial frequency domain offset of the transmission of the reference signal in a time unit occupied by the cross-time-unit transmission or repetition is determined based on a first frequency domain resource unit occupied by the cross-time-unit transmission or repetition in a first time unit occupied by the cross-time-unit transmission or repetition.

11. (canceled)

12. A communication method comprising:
receiving, based on a reference signal configuration parameter, transmission of a reference signal for cross-time-unit transmission or repetition from a base station, wherein the reference signal is configured for phase estimation, and frequency domain resources occupied by the transmission of the reference signal are less than frequency domain resources occupied by transmission of a demodulation reference signal (DMRS).

13. The communication method according to claim 12, wherein the receiving transmission of a reference signal for cross-time-unit transmission or repetition comprises:
receiving the transmission of the reference signal in at least part of time units occupied by the cross-time-unit transmission or repetition, wherein at least one time unit in part of the time units doesn't comprises the transmission of the DMRS.

14. (canceled)

15. A communication method, comprising:
configuring or receiving, for two adjacent time units in cross-time-unit transmission or repetition, signal transmission in a last symbol of a first time unit and a first symbol of a second time unit respectively, wherein the signal transmission is configured for phase estimation.

16. The communication method according to claim 15, wherein the signal transmission is transmission of the same service data or transmission of a demodulation reference signal (DMRS).

17-25. (canceled)

26. An electronic device, comprising:
at least one processor; and
a memory communicatively connected to the at least one processor, wherein
the memory stores an instruction executable by the at least one processor, and the instruction, when being executed by the at least one processor, enables the at least one processor to perform the communication method according to claim 1.

27. A non-transitory computer-readable storage medium, storing a computer instruction, wherein the computer instruction is configured to enable a computer to perform the communication method according to claim 1.

28. An electronic device, comprising:
at least one processor; and
a memory communicatively connected to the at least one processor, wherein
the memory stores an instruction executable by the at least one processor, and the instruction, when being executed by the at least one processor, enables the at least one processor to perform the communication method according to claim 12.

29. An electronic device, comprising:
at least one processor; and
a memory communicatively connected to the at least one processor, wherein
the memory stores an instruction executable by the at least one processor, and the instruction, when being executed by the at least one processor, enables the at least one processor to perform the communication method according to claim 15.

30. A non-transitory computer-readable storage medium, storing a computer instruction, wherein the computer instruction is configured to enable a computer to perform the communication method according to claim 12.

31. A non-transitory computer-readable storage medium, storing a computer instruction, wherein the computer instruction is configured to enable a computer to perform the communication method according to claim 15.
